(19) United States
(12) Patent Application Publication
(10) Pub. No.: US 2018/0315116 A1
(43) Pub. Date: Nov. 1, 2018

(54) SYSTEM FOR AUTONOMOUS CONFIGURATION OF PRODUCT DISPLAYS

(71) Applicant: Walmart Apollo, LLC, Bentonville, AR (US)

(72) Inventor: David Isauro Medina, Rogers, AR (US)

(21) Appl. No.: 15/909,944

(22) Filed: Mar. 1, 2018

Related U.S. Application Data
(60) Provisional application No. 62/492,890, filed on May 1, 2017.

(51) Int. Cl. G06Q 30/06

(52) U.S. Cl. CPC G06Q 30/0643; G06K 9/00221; G06Q 30/0631; G06Q 30/0621

(57) ABSTRACT

A system and method is provided for autonomous configuration of product displays. A set of sensors gathers sensor data associated with a user and a configurable product display within a detection zone. A display controller analyzes the sensor data to identify the user and/or a set of characteristics associated with the user. The display controller generates a set of suggested product preferences based on the user's identity and/or the set of characteristics associated with the user. The display controller identifies a suggested item associated with the configurable product display. If the suggested item is outside the user's view, the display controller autonomously changes a configuration of the product display to reorient the item toward the user. The display controller analyzes sensor data to determine if the user is receptive to the reconfigured product display. The display controller updates a preferred products database associated with the user using the feedback.

### BACKGROUND

Retail stores typically display products on shelves and display cases arranged throughout the store. For example, products may be displayed on wall shelves, shelves arranged in rows associated with aisles, inside showcases, inside counter displays, and/or on end-cap displays. However, these store shelves and displays are static. Customers typically are only able to view items on a shelf facing the customer. While viewing one side of a display, the customer typically cannot see items arranged on other sides of the display. Therefore, the customer may be unaware of all items on shelves or displays oriented away from the customer's field of view (FOV). These static product displays fail to fully engage customers and result in suboptimal utilization of display space.

### SUMMARY

Examples of the disclosure provide a system for autonomous configuration of a product display. The system includes a set of robotic product displays, a set of sensors, and a display controller. At least a portion of at least one robotic display autonomously changes configuration to re-orient at least one item relative to a position of a user. The set of sensors detects the user within a detection zone of the set of robotic product displays. The display controller is communicatively coupled to the set of robotic product displays and the set of sensors. The display controller obtains sensor data associated with the detected user, analyzes the obtained sensor data to determine a set of suggested product preferences for the user, generates configuration instructions for the at least one robotic product display based on the determined set of suggested product preferences, and controls the at least one robotic product display based on the generated configuration instructions.

Other examples provide a method for autonomously configuring product displays. A user is detected within a detection zone of a set of configurable product displays. A set of suggested product preferences for the detected user is determined. Configuration instructions are generated based on the determined set of suggested product preferences, a set of products associated with the set of configurable product displays, and a current location of the detected user. At least one configurable product display in the set of configurable product displays is autonomously reconfigured based on the generated configuration instructions.

Still other examples provide one or more computer storage devices storing computer-executable instructions for autonomous configuration of a product display. The computer-executable instructions are executed by a computer to cause the computer to perform operations, including obtaining sensor data from one or more sensors, using the sensor data to detect a user entering a location comprising a set of configurable product displays, identifying at least one characteristic associated with the detected user, determining, by the display controller a set of suggested product preferences associated with the at least one identified characteristic, and controlling, by the display controller, autonomous reconfiguration of at least one configurable product display in the set of configurable product displays based on the determined set of suggested product preferences.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a system for autonomously configuring product displays.

FIG. 2 is an exemplary block diagram illustrating a location including a plurality of configurable displays and a plurality of users.

FIG. 3 is an exemplary block diagram illustrating a set of robotic product displays.

FIG. 4 is an exemplary block diagram illustrating a set of configurable product displays.

FIG. 5 is an exemplary block diagram illustrating a configurable product display.

FIG. 6 is an exemplary flow chart illustrating operation of the display controller to autonomously reconfigure a configurable product display.

FIG. 7 is an exemplary flow chart illustrating operation of the display controller to reorient an item associated with a product display toward a user.

FIG. 8 is an exemplary flow chart illustrating operation of the display controller to process feedback associated with reconfiguration of a product display.

Corresponding reference characters indicate corresponding parts throughout the drawings.

### DETAILED DESCRIPTION

Referring to the figures, examples of the disclosure enable autonomous reconfiguration of product displays. In some examples, a display controller detects a user as the user enters a store or other retail location. The display controller analyzes sensor data associated with the user to determine a set of predicted product preferences associated with the user. The display controller changes the configuration of one or more product displays to present item(s) predicted to be of most interest to the user(s) within a field of view (FOV) of the user(s). This reconfiguration improves visibility of user preferred items, or predicted user-preferred items, and improves store performance.

In other examples, the display controller determines a set of suggested product preferences for a user based on the user's values and preferences. This autonomous reconfiguration of product displays based on a specific user's values and preferences improves customer satisfaction and improves the user's shopping experience, actively engages users during shopping, and increases goodwill.

In still other examples, a display customization component generates configuration instructions. A product display is reconfigured based on the instructions. The instructions are generated based on a determined set of suggested product preferences, a set of products associated with the product display, and/or a current location of a detected user. The configuration instructions enable reconfiguration of product displays to improve product placement and display management optimization.

In yet other examples, the configuration instructions are generated by a remote computing device, such as, but not limited to, a cloud server. The instructions are then transmitted to a display controller and/or an actuator local to the product display. The display controller and/or actuator reconfigures the product display in accordance with the configuration instructions. A cloud server or other computing device generating the configuration instructions remotely from the product display conserves memory and reduces processor load.

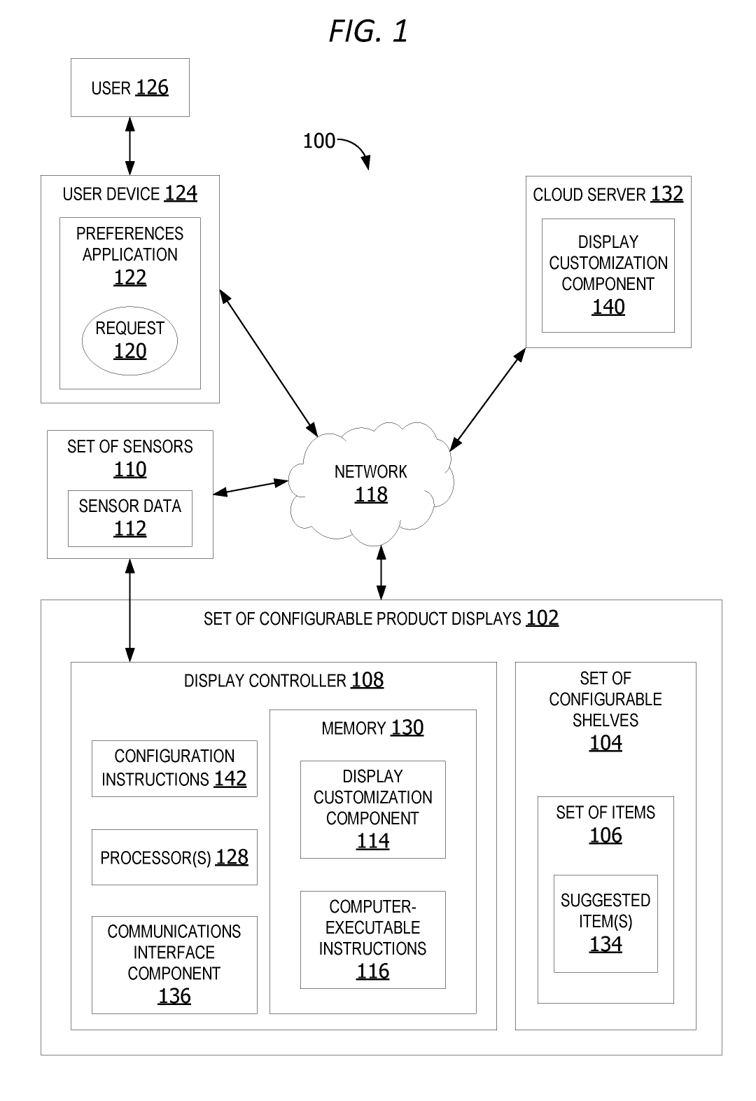

Referring again to FIG. 1, an exemplary block diagram is provided, illustrating a system 100 for autonomously configuring a set of one or more configurable product displays 102. A configurable product display includes a set of one or more configurable shelves 104. In some examples, a configurable product display includes two or more sides, faces, or surfaces of the display. For example, a configurable product display may be cube shaped or rectangular shaped. The display in this example has four sides or four faces. If a user is viewing one side of the display, the user may be unable to view items on the other three sides of the display. The configurable product display changes the configuration of the sides and/or shelves of the display by rotating or re-orienting one or more shelves of the set of configurable shelves 104 to present items to the user that would otherwise be outside the user's current FOV. In some examples, the configurable product display rotates or turns to change the shelf or face of the display currently within the FOV of the user. In other examples, a shelf moves horizontally or vertically to change configuration.

A configurable product display may be a triangular shaped display, in another example. If a user is looking at one side of the display, the user is typically unable to view items on the other two sides without walking around the display. In still other examples, the configurable product display may be a circular, round, oval, or donut shaped display. A display may also be a tiered display having multiple levels or tiers. If a user is looking at items displayed on a first level or top tier at eye level, the user may not see or notice items located on a middle level or bottom/lower tier below eye level.

A configurable shelf includes any type of shelf, hanger, showcase, endcap, container, sliding tray, cabinet, peg, rack, or other device for displaying one or more items in a location or retail space.

A set of one or more items 106 is associated with one or more shelves in the set of configurable shelves 104. An item includes any type of goods. For example, but without limitation, an item may include clothing items, comestibles, printed material, toys, cosmetics, shoes, gift cards, storage containers, decorative items, hardware, digital video disks (DVDs), or any other products. An item may be located inside a shelf, resting on a shelf, hanging from a peg or bracket associated with a shelf, stacked on top of one or more other items resting on a shelf, inside a showcase or bin, or otherwise associated with at least a portion of the set of configurable product displays 102.

In the example of FIG. 1, a display controller 108 autonomously changes a configuration of one or more of the configurable product displays to re-orient or change a configuration of one or more of the items on display relative to at least one user. The display controller 108 changes the configuration of the product displays to place one or more items within the view of one or more user(s) or otherwise improve the visibility of one or more items within the product displays relative to the user(s).

The display controller 108 may be implemented as a computing device executing computer-executable instructions 116 (e.g., as application programs, operating system functionality, or both) to autonomously reconfigure one or more configurable product displays.

The display controller 108 is associated with the set of configurable product displays 102. In this example, the display controller 108 is co-located with the set of configurable displays. The display controller 108 in this example is attached or otherwise local to and communicatively coupled to at least a portion of one or more product displays in the set of configurable product displays 102.

However, in other examples, the display controller 108 may be located remotely relative to the set of configurable product displays 102 (not shown). In these examples, the display controller 108 communicates with the set of configurable product displays 102 via a network 118.

The network 118 is implemented by one or more physical network components, such as, but without limitation, routers, switches, network interface cards (NICs), and other network devices. The network 118 may be any type of network for enabling communications with remote computing devices, such as, but not limited to, a local area network (LAN), a subnet, a wide area network (WAN), a wireless (Wi-Fi) network, or any other type of network. In this example, the network 118 is a WAN accessible to the public, such as the Internet.

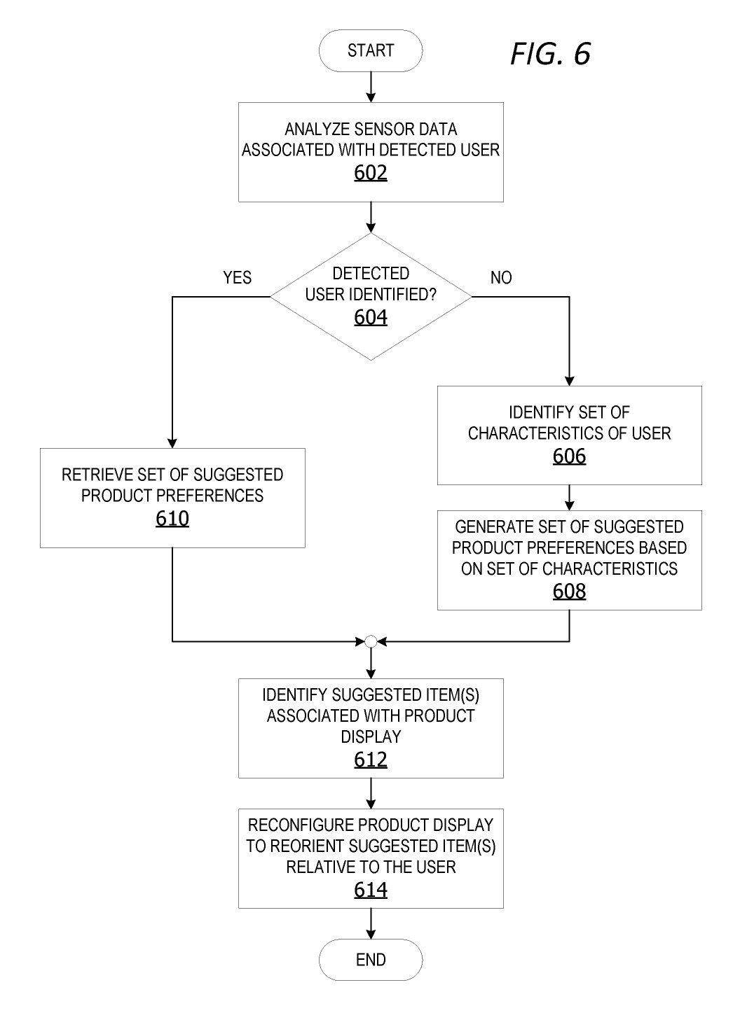

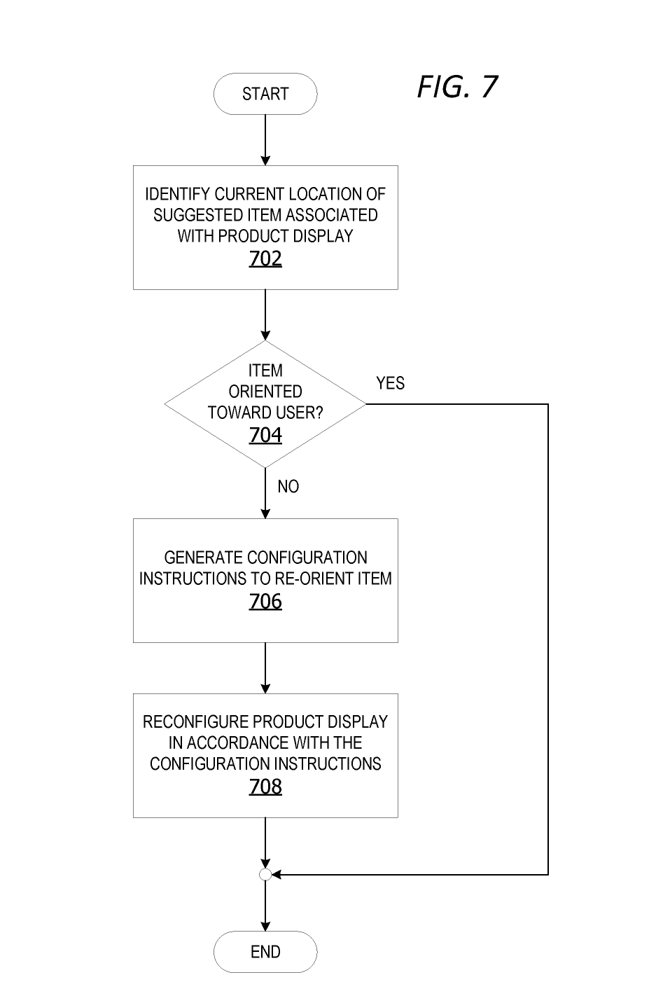

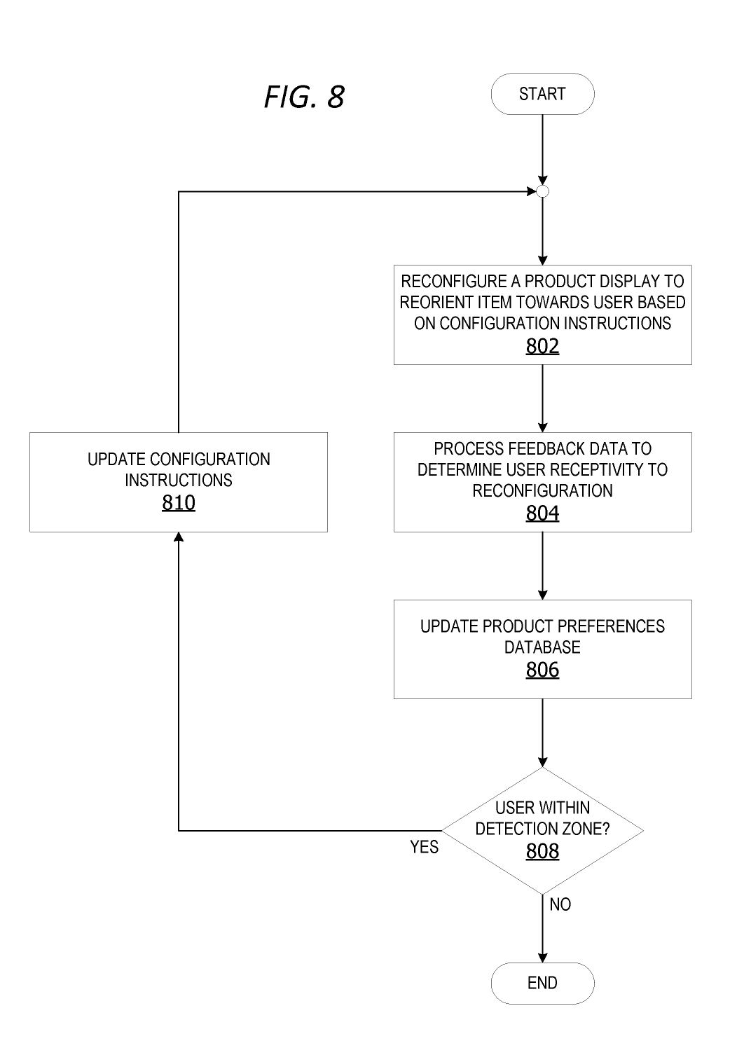

In some examples, the display controller 108 includes one or more processor(s) 128 and a memory 130. The processor(s) 128 include any quantity of processing units. The processor(s) are programmed to execute the computer-executable instructions 116 stored in memory 130 to autonomously reconfigure at least a portion of at least one configurable product display in the set of configurable product displays 102. The computer-executable instructions 116 may be performed by a single processor or by multiple processors within the processor(s) 128, or performed by a processor external to the display controller 108. In some examples, the processor is programmed to execute instructions such as those illustrated in the figures (e.g., FIG. 6, FIG. 7, and FIG. 8).

The computing device further has one or more computer readable media such as the memory 130. The memory 130 includes any quantity of media associated with or accessible by the display controller 108. The memory 130 may be internal to the display controller 108 (as shown in FIG. 1), external to the display controller 108 (not shown), or both (not shown). In some examples, the memory 130 includes read-only memory (ROM) and/or memory wired into an analog computing device.

The memory 130 stores data, such as one or more applications. The applications, when executed by the processor(s) 128, operate to perform functionality of the display controller 108. The applications may communicate with counterpart applications or services such as web services accessible via the network 118. For example, the applications may represent downloaded client-side applications that correspond to server-side services executing in a cloud. For example, the display controller 108 may download the display customization component 114 from the cloud server 132. Likewise, the user device 124 in some examples downloads the preferences application 122 from the cloud server 132.

The memory 130 further stores the display customization component 114. The display customization component 114, when executed by the processor(s) 128 of the display controller 108, causes the processor(s) 128 to detect a user within a detection zone of a set of configurable product displays; determine a set of suggested product preferences for the detected user; generate configuration instructions based on the determined set of suggested product preferences, a set of products associated with the set of configurable product displays, and/or a current location of the detected user; and autonomously reconfigure at least one configurable product display in the set of configurable product displays based on the generated configuration instructions.

In some examples, the display controller 108 identifies one or more suggested item(s) 134 displayed on a configurable product display. The suggested item(s) include one or more items predicted to be of interest to the user. A machine learning component (not shown) may optionally be included in the display controller 108. The machine learning component utilizes analyzed sensor data 112 and preferences data with matching algorithms and predictive modeling to make predictions regarding a product of interest. The predictions are utilized to generate the set of suggested product preferences.

The display controller 108 controls the set of configurable product displays 102 to reorient one or more shelves of the set of configurable shelves 104, which in turn reorients the suggested item(s) 134. The reorientation controlled by display controller 108 places the item(s) 134 within a FOV of the user and/or a configuration having an improved visibility relative to the user. The reconfiguration places the item(s) into a position that is more prominent and/or more visible to the user.

The display controller 108 may receive or obtain sensor data 112 from a set of sensors 110. The set of sensors 110 may be communicatively coupled to display controller 108. In some examples, the set of sensors may be in direct communication with display controller 108. In other examples, the set of sensors may communicate with display controller 108 via network 118. The set of sensors includes one or more physical sensors for gathering data associated with one or more user(s) within a detection zone of the set of sensors 110. The detection zone is an area associated with the set of configurable product displays 102 and within range of one or more of the sensors in the set of sensors 110.

The set of sensors in some examples includes, without limitation, one or more image capture devices, microphone(s), infrared (IR) sensor(s), pressure sensor(s), touch sensor(s), radio frequency identification (RFID) sensors, motion sensor(s), global positioning system (GPS) systems, or any other types of sensors. An image capture device includes any type of device for capturing image data, such as, but without limitation, a camera. A camera may be a still image camera or a video camera.

The display controller 108 obtains sensor data 112 associated with the detection zone from the set of sensors 110. The sensor data 112 in some examples includes image data. In some examples, a display customization component 114 of the display controller 108 analyzes the sensor data 112 to detect users entering the detection zone or detect users within the detection zone associated with the set of configurable product displays 102. For example, the sensor data 112 may include image data of a portion of the detection zone. The display customization component 114 analyzes the image data to identify a new user entering the detection zone.

In other examples, the display controller 108 receives a request 120 from a preferences application 122 running on a user device 124. The user device 124 may include any type of mobile computing device or any other portable device associated with a user 126. In some examples, the user device includes a cellular telephone, laptop, tablet, computing pad, netbook, gaming device, smart watch, and/or portable media player.

The request 120 is a message or signal sent by the user device 124 to notify the display controller 108 of the user 126 entering the detection zone associated with the set of configurable product displays 102. The request 120 may be implemented as a wireless signal, BLUETOOTH signal, NFC signal, RFID signal, or any other request signal generated by the user device 124. In some examples, the user device 124 sends the request 120 as the user 126 enters a location associated with configurable product displays. In other examples, the user device 124 sends the request 120 as the user 126 approaches a configurable product display or moves within a predetermined range of the configurable product display.

In some examples, the preferences application 122 detects a wireless network (Wi-Fi) associated with a detection zone of the set of configurable product displays 102. In response to detecting the network, the preferences application 122 sends the request 120. The request 120 may include user preferences data. The user preferences data is utilized by the display controller 108 to determine the set of suggested product preferences. The set of product preferences, the current set of items 106, and the user's current location are utilized to identify the one or more suggested item(s) 134.

The display controller 108 receives the request 120 and utilizes the request 120 to identify the user. The display controller reconfigures one or more configurable product displays based on preferences for the identified user.

In still other examples, the display controller includes a communications interface component 136. The communications interface component 136 includes a network interface card and/or computer-executable instructions (e.g., a driver) for operating the network interface card. Communication between the display controller 108 and other devices may occur using any protocol or mechanism over any wired or wireless connection. In some examples, the communications interface is operable with short range communication technologies such as by using near-field communication (NFC) tags.

A set of databases in some examples may include product preferences data. The display controller 108 retrieves the product preferences data and/or user profile data from the set of databases. The set of databases may be stored on one or more data storage devices located locally to the display controller 108. In other examples, the set of databases may be stored on one or more remote data storage devices. Data stored on remote data storage device(s) may be accessed by the display controller 108 via the network 118.

The cloud server 132 in yet other examples includes a display customization component 140. The display customization component 140 receives a notification from the display controller 108. The notification in some examples includes the sensor data 112. The display customization component 140 running on the cloud platform retrieves preferences data from the set of databases and/or analyzes the sensor data to detect the user, identify the user, identify one or more characteristics of the user, and/or determine a set of suggested product preferences. The cloud server 132 then transmits the determined set of suggested product preferences to the display controller 108. The display controller 108 then controls the reconfiguration of the set of configurable product displays 102 to reorient the suggested item(s) 134 toward the detected user.

In still other examples, the display customization component 140 on the cloud server 132 analyzes the sensor data, determines the set of suggested product preferences, and generates configuration instructions 142. The display customization component 140 then sends the configuration instructions 142 to the display controller 108. The display controller 108 reconfigures at least a portion of the set of configurable product displays 102 in accordance with the configuration instructions received from the cloud server 132.

In this example, the display controller controls the mechanical reconfiguration of the product display. However, in other examples, the mechanical reconfiguration may be performed by an actuator or other robotic mechanism controlled remotely by the display controller. In other words, the display controller in some examples transmits instructions to a local robotic component or actuator that performs the physical manipulations and reconfiguration of the product display shelves.

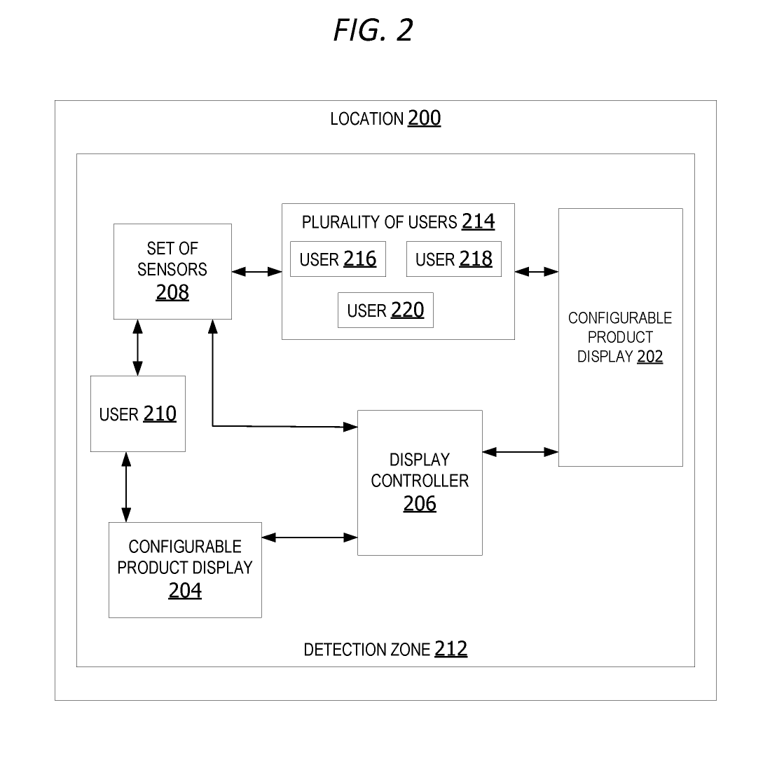

FIG. 2 is an exemplary block diagram illustrating a location 200 including a plurality of configurable displays and a plurality of users. The location 200 includes a set of one or more configurable product displays. The location 200 in some non-limiting examples is a retail store.

In this example, the set of configurable product displays includes two displays, configurable product display 202 and 204. However, any number of configurable displays is contemplated by the description herein. In other examples, the set of configurable product displays may include a single display, as well as three or more displays within the location 200.

Display controller 206 may be an illustrative example of one implementation of display controller 108 in FIG. 1. The display controller 206 in this example is located externally to, or remote from, the configurable product displays and the set of sensors 208. The display controller 206 may communicate with the set of sensors and/or the configurable product displays via a network. The network may be a wired or wireless network, such as a LAN or a WAN.

The display controller 206 in this example obtains sensor data from the set of sensors 208. The display controller 206 analyzes the sensor data to identify a detected user within a detection zone 212 of the set of sensors 208. The location 200 in this non-limiting example includes a single detection zone 212. However, in other examples, the location 200 may include multiple detection zones associated with a plurality of configurable shelves and a plurality of sets of sensors.

In some examples, the sensor data includes images of users entering the location 200 or moving throughout the location 200. The images may be stored temporarily for analysis and then deleted following analysis. Known users may be users that are registered to a system associated with location 200, or otherwise have opted in to a service associated with location 200. Known users may optionally choose to provide an image of the user, such as an image of the user's face along with identifying information, to be personally identified by a service or system associated with the location 200 and/or display controller 206. The user provides consent when the user uploads their photo for utilization during generation of customized product displays for the user. Known users may optionally provide user product preferences information. The user-provided images for known/identified users and/or user-provided product preferences may be stored in a user-provided information database based on user consent.

The display controller 206 analyzes the sensor data obtained from set of sensors 208 for an image of the user 210. If image data is identified, the display controller 206 retrieves image data from the database of user-provided information. The display controller 206 compares the temporarily captured image data of the user 210 with images of known users from the database of user-provided information. The comparison may be performed using facial recognition algorithms or any other suitable matching algorithms.

If the user is identified using the image data, the display controller 206 retrieves a set of suggested product preferences for the identified user 210. The set of suggested product preferences may be pre-generated and stored in a database or other data storage for the identified user 210. When the user is identified, the set of suggested product preferences for the identified user is retrieved and utilized for configuring configurable product display(s).

The display controller 206 in other examples generates the set of product preferences for the identified user 210 dynamically, in real-time, based on the user profile data, past transaction history, the user's current companions, the day of the week, the month or season, upcoming holidays, etc.

In still other examples, the set of suggested product preferences for an identified user 210 is pre-generated and updated based on current events and/or updates to the user's profile data, companions, holidays, weekday, month, season, recent transactions, etc. For example, if the pre-generated set of suggested product preferences includes gardening items, the set of suggested product preferences may be updated to remove those gardening items in the winter. Likewise, the set of product preferences for the identified user 210 may be retrieved and then updated to add candy and/or Halloween-related items during the month of October.

If the user is not identified, the display controller 206 analyzes the image data to identify one or more characteristics of the user. A characteristic is a feature, trait, or attribute of the user. Characteristics may include, without limitation, user interests, gender, age, age range, companions, appearance, hair style, clothing style, etc. For example, a user's characteristics could include a local sports jersey worn by the user, whether the user is male or female, whether the user is young or old, whether the user is alone or with children, whether the user wears glasses, whether the user has long hair or short hair, etc. In some examples, characteristics of an unidentified user include context awareness, such as a store location, community information, weather, season, holidays, or other information influencing user preferences.

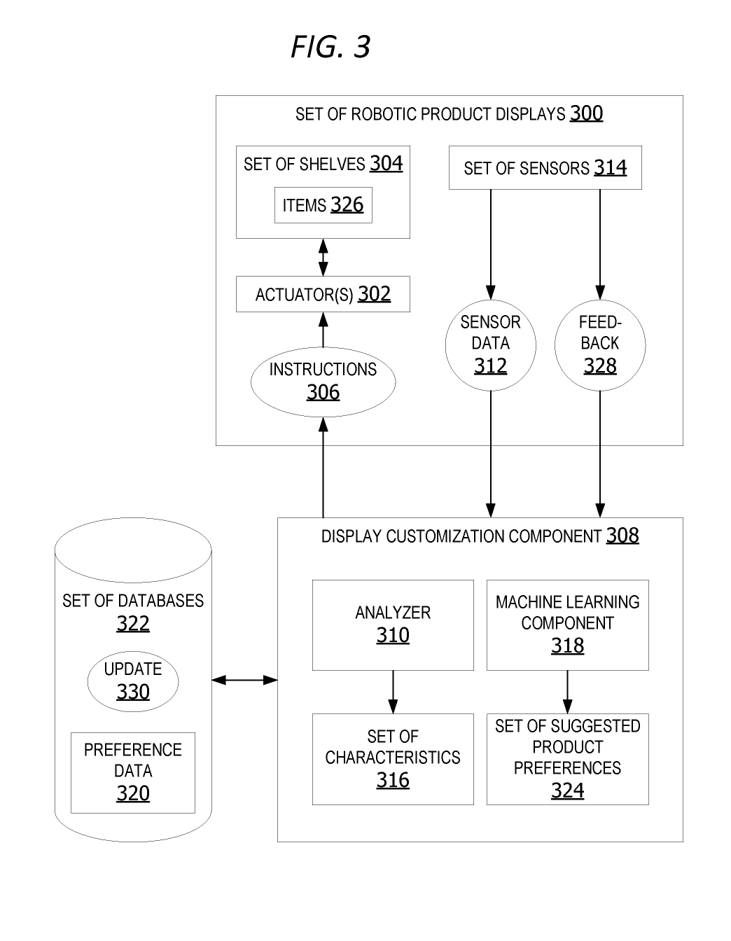

An analyzer (shown in FIG. 3 below) of the display controller in some examples analyses sensor data, including image data, to identify characteristics of the user. In some examples, the analyzer performs image analysis on image data to identify characteristics of the user based on one or more images of the user and/or other data associated with the user or location 200. The images are digital images generated by a digital camera in some examples. In other examples, the images are IR images, or other types of images.

The analyzer in some examples uses pattern recognition, entity recognition, facial recognition, and/or other image processing techniques to extract information from the image. The extracted information is utilized by the analyzer to identify characteristics of the user and/or identify the user. For example, the analyzer may perform image analysis, which may be utilized to determine whether a user is accompanied by children, carrying an umbrella, wearing a baseball cap, or wearing glasses, as some illustrative examples. Image analysis may also be utilized to identify a known user.

For example, if the user 210 is wearing a sports jersey, the user may be identified by the display controller as having a “sports fan” or “sports enthusiast” characteristic. If the user is carrying reusable cloth shopping bags, the user may be associated with an “environmentally-aware” characteristic.

The display controller 206 utilizes the one or more characteristics of the user to makes predictions regarding products of interest. In some examples, the predictions are made by a machine learning component (shown in FIG. 3 below). The predictions are utilized to generate and/or retrieve a set of suggested product preferences based on the user's identity or characteristic(s) of the user.

The set of suggested product preferences are generated or retrieved by the display control in some examples by a machine learning component. The machine learning component predicts products of interest based on machine learning, predictive behavior modeling, pattern analysis, and/or other predictive modeling. The machine learning component utilizes the characteristic(s), products correlated to the characteristic(s), patterns of behavior for a known user, patterns of behavior for users associated with particular characteristics, and other user-provided information.

If a user characteristic includes “sports”, the display controller 206 in some examples utilizes the “sports” characteristics to generate a set of suggested product preferences including sports-related items and/or items having a sports-related theme. The set of suggested product preferences may be generated in real-time or pre-generated.

For example, based on store location, community information, time of year, and/or other information such as social media and/or newsfeeds, the display controller 206 may identify a local or national sporting event scheduled in the near future relative to the detection of user 210 in detection zone 212. This illustrative identification of characteristics and context awareness by display controller 206 may provide for display controller 206 generating suggested product preferences related to food items, such as recognized or typical tailgating fare, snack items associated with sporting events, or disposable paper goods, for example.

In another example, if display controller 206 identifies from sensor data obtained from set of sensors 208 that the user 210 is accompanied by an infant, the identified characteristics of the user 210 may include parent/caregiver to a baby. The display controller 206 utilizes this characteristic to generate a set of suggested product preferences associated with baby products, child care products, and parenting-related products.

The display controller in other examples may identify multiple characteristics of the user. For examples, the display controller may analyze sensor data to determine the user is a sports fan based on the user wearing a sports jersey, a parent/guardian based on the user being accompanied by one or more children, and an exercise enthusiast or health conscious individual based on a determination that the user is wearing a pedometer. The set of suggested product preferences may include products related to parenting, sports, exercise and fitness. The set of suggested product preferences in this example may also include items associated with children, such as toys, children's clothing, children's shoes, etc.

The display controller utilizes the multiple characteristics of the unidentified user to generate a set of suggested product preferences. The one or more products in the set of product preferences are selected based on one or more of the characteristics. In some examples, the characteristics are ranked in accordance with a weight or priority. The characteristics may be ranked in a hierarchy, order of priority, in accordance with a weight, or in accordance with primary characteristics and secondary characteristics.

Products currently on display or products plentiful in stock may be given a higher weight or priority than products that are not in stock or low stock, for example. Items on sale or special offer may be given higher priority over items at regular price. In still other examples, seasonal items may be given greater weight. Moreover, some characteristics may be given very low weight or discarded as unimportant. For example, a user characteristic indicating the user is carrying an umbrella when it is identified as currently raining may be given low weight or disregarded as having little/no relevance to selecting products of interest.

For example, characteristics may be given a weight or priority based on circumstances or current events. A “parent” characteristic is given greater weight than an exercise/sports characteristic where a child is currently accompanying the parent. In this example, products related to children are given greater priority where the child is present. If the child is absent, the exercise/sports characteristic may be given a greater priority over the parent characteristic. In this example, sports-related items may be suggested preferentially over child-related items when the child is absent.

Characteristics are weighted in some examples based on the time of year, holidays, and events. An “action movie” and “spy movie” characteristic is given higher priority over a “fishing/camping hobbyist” characteristic on the weekend a new James Bond movie is released, for example. In this example, the movie-related recommendation is given priority over camping equipment recommendations. However, in other examples, recommendations of fishing equipment are given priority during fishing/camping season.

Characteristics may be classified as primary or secondary by a user as well. For example, a user having a “humanitarian” characteristic and a “painting hobby” characteristic, may rank their “humanitarian”-related interests as primary while the painting hobby is secondary. In these cases, the display controller prioritizes products associated with humanitarian efforts, such as products benefiting charities, over paint supplies, based on user-defined preferences.

The display controller may also rank characteristics as primary or secondary based on feedback, purchase history, user-provided information, and machine learning. For example, if a user consistently utilizes coupons, the display controller may rank a “coupon” or “sale/promotional item” characteristic as primary while one or more other characteristics are ranked secondary.

In other examples, the user may be a painter by profession that enjoys bike riding as a hobby. The information associated with the user's profession and hobbies may be provided by the user. In this example, the painting characteristic is a primary characteristic which would receive greater priority over other characteristics, such as biking.

In still other examples, combinations of characteristics may be utilized to generate a set of suggested product preferences. If characteristics include home improvement/do-it-yourself and reading, this combination of characteristics are used in some examples to generate a set of suggested product preferences including home improvement books. In these non-limiting examples, all identified characteristics of a user may be utilized for generating the set of suggested product preferences.

In other examples, a sub-set of the characteristics is utilized to generate the set of suggested product preferences. The sub-set includes one or more characteristics but not all the characteristics. The characteristics in the sub-set may be selected based on the ranking, prioritization, current events, or other criteria. For example, the sub-set may include only primary characteristics but exclude secondary characteristics. In still other examples, the sub-set may exclude items that are not currently on display or in stock.

The display controller 206 identifies one or more suggested items on the configurable product display 204 based on the identified set of suggested product preferences, the current location of the user 210, and the items currently being displayed on the configurable product display 204. If the suggested item(s) are already oriented towards the user 210, no change to the configuration is necessary. However, if the suggested item(s) are oriented outside the FOV of the user, the display controller changes the configuration of one or more shelves of the configurable product display 204 to bring the suggested item(s) within the FOV of the user 210. In other examples, if the suggested item(s) cannot be brought within the FOV of the user, the display controller changes the configuration of the display to improve the visibility or prominence of the suggested item(s) to engage the user 210 or bring the suggested item(s) within the user's notice/awareness.

The display controller 206 detects a plurality of users 214 within the location 200. The plurality of users 214 are within a proximity to the configurable product display 202. In some examples, the display controller 206 analyzes the sensor data to identify one or more characteristics for each of the individual users, user 216, user 218, and user 220, within the detected plurality of users 214. The display controller 206 determines an average user for the plurality of users 214. The average user is not an actual user. The average user is a representation of the plurality of users 214. The average user is generated based on identified characteristics of the actual users, representing one or more characteristics that correspond to one or more common characteristics shared by all users in the plurality of users.

For example, if user 216, user 218, and user 220 are dressed differently, have different genders, and all have gray hair, the display controller 206 determines that the plurality of users share a “senior citizen” characteristic. In this example, the average user has the common characteristic “senior citizen.” The display controller 206 generates a set of suggested product preferences based on the one or more identified common characteristics of the average user. The display controller uses this set of suggested product preferences to reconfigure the configurable product display 202 relative to the entire plurality of users 214 based on the predicted preferences of the representative average user determined by display controller 206.

In another example, if a common characteristic is not identified for all users in the plurality of users 214, the display controller 206 identifies a sub-set of detected users within the plurality of users 214 based on one or more shared characteristics of the sub-set of detected users. As an illustrative example, a sub-set may include a family group, a group of users of a similar age or age range, a group of the same gender, a group of users having long hair, a group of users wearing hats, a group of users wearing clothing with sports team identifiers, a group of users with facial hair, or any other characteristic that is common to two or more of the users in the plurality of users.

For example, if display controller 206 determines that the only machine-recognized shared characteristic is that user 216 and 218 both have long hair and user 220 has very short hair, the users 216 and 218 may be placed in a sub-group recognized as having long hair, and therefore, potentially interested in hair styling products. The display controller 206 prioritizes the sub-group recognized as having long hair because it is a larger group. The display controller 206 then generates a set of suggested product preferences including products associated with female consumers. The display controller uses this set of suggested product preferences to reconfigure the configurable product display 202 relative to the sub-group including users 216 and 218.

In yet another example, the display controller 206 identifies one or more individual users of the detected plurality of users 214 using the sensor data. For example, the display controller 206 analyzes the sensor data and identifies user 218 as a known user but is unable to identify user 216 or user 220. The display controller determines that the identified user 218 is a priority user because there is known preference data available for the identified user 218. The display controller may generate suggested product preferences for the priority user. The display controller controls the configurable product display 202 based on the generated suggested product preferences for the priority user, in this example.

In still other examples, the display controller 206 matches an unidentified user to a known user profile based on one or more characteristics in common. For example, an unidentified pre-teen boy may be matched to a known user profile for another pre-teen boy. The known preferences for this known pre-teen boy are applied to the unidentified boy for the purpose of generating a set of suggested product preferences and reconfiguring product displays for the unidentified boy.

In another example, user 218 may be running a preferences application associated with location 200 and/or display controller 206, such as preferences application 122 in FIG. 1. In this example, the application actively pings the display controller to orient product display(s) based on the user's preferences provided by the application data. The display controller prioritizes user 218 running the preferences application on their user device, in this example. The display controller 206 retrieves a set of suggested product preferences for the identified user based on the identified user having a higher priority than the unidentified users. The display controller uses this set of suggested product preferences to reconfigure the configurable product display 202 relative to the higher priority, identified user.

In some examples, the display controller configures product displays towards an identified user rather than unidentified users because accuracy and relevance of the reoriented items is likely to be higher regarding the identified user. Therefore, the reconfiguration is more effective and provides better results/return.

In still other examples, the display controller may select one user out of the plurality of users to focus reconfiguration of product displays based on a determination the selected user will be more receptive to the reconfigured display. For example, if a configurable product display includes hair care products, the machine learning component of the display controller may select a user having long hair for customization of the product display configuration because the user with long hair may be more likely to prefer hair care products. A user without hair in this example is not selected for customization of the product display configuration because the user without hair is less likely to be interested in hair care products.

In another example, the display controller may select a young user for customization of product display configuration if the product display includes clothing, music, or books popular with youth. In this example, the display controller may prioritize younger users over older users who are less likely to be interested in products popular among teenagers and young adults.

FIG. 3 is an exemplary block diagram illustrating a set of robotic product displays. The set of robotic product displays 300 is a set of one or more configurable product displays including one or more actuator(s) 302 for autonomously changing a configuration of a set of shelves 304 in response to configuration instructions 306. The actuator(s) 302 are implemented as a motorized shelf, motorized turntable, robotic arm, conveyor belt, lifting mechanism, rotating mechanism or electro-mechanical component for moving a portion of a configurable product display. The actuator(s) 302 may be attached to a set of shelves, a single shelf, a portion of a shelf, a base of a robotic product display, or a side of a robotic display. An actuator may be powered by a battery, an electric power supply, solar power, or other power source.

In some examples, the actuator(s) 302 are integrated with the display controller. In other examples, the actuator(s) are separate from the display controller. In these examples, the display controller controls the actuator by sending configuration instructions to the actuator(s) 302 to control the operation of the actuator(s) 302. In still other examples, the display controller receives the configuration instructions from another remote computing device and implements the configuration instructions to control the operation of the actuator(s) 302 to reconfigure at least a portion of the configuration product displays.

The configuration instructions 306 are generated by a display customization component 308. The display customization component 308 may be running on a display controller local to the set of robotic product displays 300 or running on a remote cloud server.

In this example, an analyzer 310 obtains sensor data 312 from a set of sensors 314 associated with the set of robotic product displays 300. The analyzer 310 identifies a set of characteristics 316 of a user within a detection zone of the set of robotic product displays 300. The set of characteristics 316 may include general characteristics based on an appearance of the user, such as, but not limited to, an age range of the user, a demographic category, parental status, weight, fitness level, hobbies, etc. In some examples, an analysis may include an identification of the user based on facial recognition, identification of a user device associated with the user, the user opting-in to the display customization using a user device, or a user otherwise requesting display customization via a user interface associated with the user device running a preferences application.

A display customization component 308 retrieves preferences data 320 corresponding to the set of characteristics 316 from a set of databases 322. The set of databases 322 may include one or more databases stored on one or more data storage devices. In some examples, the set of databases 322 includes a product preferences database. The product preferences database includes product preferences profiles. A product preferences profile includes preferences data for an identified user. The preferences data includes preferred products, brands, and categories of items preferred by an identified user. In some examples, the preferences data may be provided by the user when the user opts-in to the customized product display service and/or the customer downloads the preferences application to the user's mobile device.

The products preferences data may also include preferred products, brands, and categories of items associated with one or more characteristics for an unidentified user. The preferences data correlates one or more products, types of products, categories of products, and/or brands of products with a general characteristic of a non-specific user. For example, the preferences data may indicate that boys between the ages of six and ten typically prefer superhero-themed toys and clothing.

The preferences data 320 may include user-provided preferences data for known/identified users. If the user is unidentified, the preferences data 320 includes product preferences corresponding to one or more characteristics in the set of characteristics 316 associated with the user.

The machine learning component 318 analyzes the preferences data 320 to generate a set of suggested product preferences 324 for the detected user. The machine learning component in some non-limiting examples utilizes analyzed sensor data, preferences data, user feedback, and other data associated with the user's preferences to generate the set of suggested product preferences 324. In some examples, the machine learning component 318 utilizes matching algorithms and predictive modeling to generate the set of suggested product preferences 324.

The set of suggested product preferences 324 includes one or more products or types of products of potential interest to the user. In some examples, the set of suggested product preferences 324 only includes items associated with one or more configurable product displays. Items not displayed on or in a configurable product display are excluded from the set of suggested product preferences 324. The set of suggested product preferences 324 is utilized to reconfigure one or more of the configurable product displays to reorient an item of potential interest towards the user.

The machine learning component 318 in some examples compares the current set of items 326 associated with the set of shelves 304 and the set of suggested product preferences 324 to identify one or more suggested item(s) currently displayed on the set of shelves that are of potential interest to the user based on the user's characteristics, identity, user-provided preferences, and any known user values. In some examples, the machine learning component 318 determines which products are currently displayed on the set of shelves prior to generating the set of suggested product preferences.

In still other examples, the machine learning component 318 analyzes the sensor data, user preferences data, and user history data to anticipate user actions. User history data may include, for example, transaction history associated with a known user and/or transaction history associated with a detected user device. For example, the machine learning component 318 makes predictions regarding where in a store the user may go next and/or identify which items the user may be interested in selecting. For example, if the user selects pie crust from the display and the user is known to prefer baking, the machine learning component may predict that the user will be moving towards an aisle containing baking goods rather than an aisle containing snack food items.

In another example, if a user is looking at a turkey, the machine learning component may predict that the user will next go to a section of the store containing stuffing, cranberries, or other items frequently purchased in conjunction with turkey.

The display controller may send configuration instructions ahead of the user to the configurable displays on the next aisle or next area of the store in which the user is predicted to walk next.

The display customization component determines if the suggested item(s) are currently oriented towards the user based on the user's current location and the current location of the suggested item(s) on the set of shelves. An item is oriented towards the user if the item is displayed on a portion of the set of robotic displays 300 that is within the FOV of the user or otherwise facing the user. An item is oriented towards the user if the item would be visible to the user if the user is looking in a direction of a robotic product display or looking at a portion of the set of robotic product displays 300. If the items are oriented towards the user, no further action is necessary. If the items are not oriented towards the user, the user would not see the item(s) if the user looked at the robotic product displays. The display customization component 308 generates configuration instructions 306 to change the configuration of one or more shelves in the set of shelves 304 to reorient the suggested item(s) towards the user.

In some examples, the configuration of the set of robotic product displays is changed by rotating one or more of the shelves. The shelves may be rotated clockwise or counterclockwise to change the configuration of the shelves. In other examples, the configuration is changed by moving a shelf horizontally or vertically to change the orientation of the shelf.

The set of sensors 314 gathers feedback 328 following the reconfiguration of all or a portion of the robotic product displays 300 in some examples. The feedback 328 is analyzed by the display customization component to determine if the user engaged with the suggested item(s) following the reorientation of the suggested item(s). A user engages with a suggested item if the user purchases the item, picks up the item, touches the item, looks at the item, or otherwise notices the item. In some examples, the system determines user engagement with a suggested item based on a threshold period of time associated with the user interaction. For example, when analyzing feedback including sensor data indicating that the user is looking or has looked at the item, a pre-determined threshold may be used to determine whether the identified looking constitutes user engagement, such that a glance or other look below the threshold may not be considered engagement while a longer look that meets or exceeds the threshold constitutes user engagement. A user remains disengaged if the user fails to looks in the direction of the item following the reconfiguration.

In some examples, the feedback indicates whether the detected user selected at least one item from the autonomously reconfigured configurable product display, whether the detected user purchased at least one item form the reconfigured configurable product display, whether the detected user indicated an interest in the suggested item(s) re-oriented toward the detected user, whether the user looked at the suggested item(s), or whether the detected user ignored the autonomously reconfigured configurable product display.

Feedback is obtained in some examples from a point of sale (POS) device. The system obtains data from one or more POS devices, such as data for a particular time frame associated with the detection of the user. The POS data is analyzed to determine if a transaction was completed for the item selected from a configurable product display. The display controller extrapolates that the item was purchased based on this POS data.

The machine learning component utilizes the feedback and/or updated preferences data to refine the product suggestions generated in the future. For example, if the user ignores reconfiguration of a product display to reorient a hair care product towards the user, the machine learning component will not suggest that same hair care product on the user's next visit.

In other examples, if feedback 328 indicates the user ignores a suggested board game but selects a selected video game, the machine learning component will prioritize video game suggestions for the user during future visits and minimize or avoid suggesting board games on the user's next visit based on the feedback 328.

The display customization component 308 performs an update 330 of the preferences data 320 in the set of databases based on the feedback 328. For example, if the feedback 328 indicates the user failed to engage or otherwise show interest in a soda display following a reconfiguration but did engage with an organic juice, the update 330 to the preferences data 320 for the user may indicate a user preference for organic and/or natural products.

The updated preferences data is utilized by the display controller to generate new or updated configuration instructions. The configuration instructions may be used to reconfigure one or more configurable product displays to orient one or more items towards one or more users. The new configuration instructions generated based on the updated preferences data in some examples is used to reconfigure product displays for the same user on the same visit to the location. In still other examples, the update is used to reconfigure one or more configurable product displays for the same user on a different visit to the location. In this manner, the display controller utilizes sensor data to monitor or track the user moving through the location and determine which items the user grabs or looks at and which items the user ignores.

In yet another example, the update is used to reconfigure one or more configurable product displays for a different user on a different visit. For example, the updated product preferences data for an identified teenage girl may be used to reconfigure product displays for an unidentified teenage girl that shares one or more characteristics with the identified teenage girl.

In other examples, the set of databases 322 optionally includes a product display configuration database. The product display configuration database identifies a location of items on the configuration product display. For example, the product display configuration database may indicate that girls' shoes are located on a first side of a display while boys' shoes are located on an opposite side of the display. If a boy is approaching the display, the display controller utilizes the product display configuration data to reconfigure the display so that the side displaying the boys' shoes will be facing the first user. However, if the boy appears uninterested in the shoes and a second, female user approaches the display, the display controller utilizes the feedback sensor data to change the configuration of the display again to present the girls' shoes to the second user. The display controller may obtain more feedback data to determine if the second user is engaged by the reconfiguration.

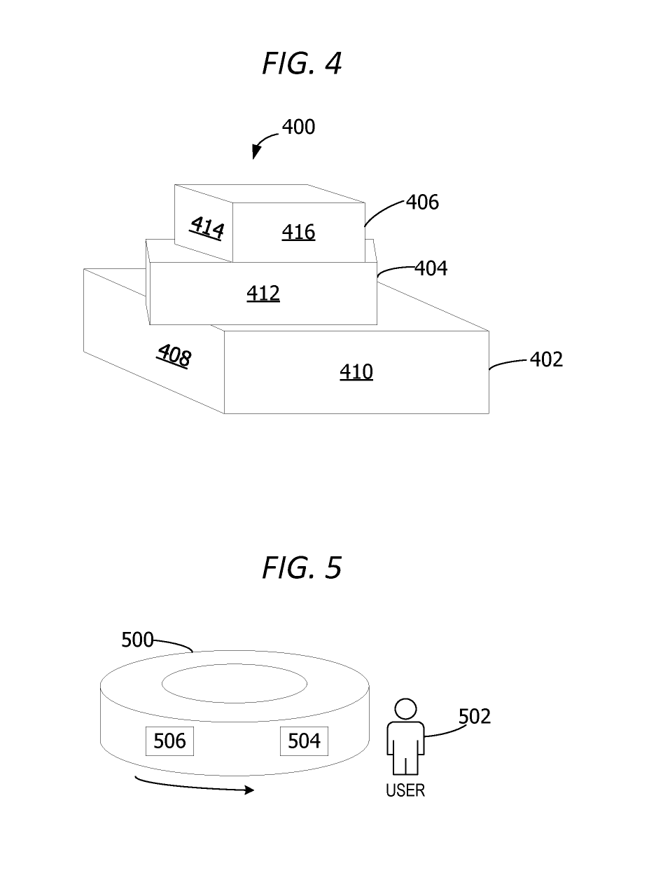

FIG. 4 is an exemplary block diagram illustrating a set of configurable product displays. The set of configurable product displays 400 is a tiered set of displays. The tiered set of displays includes a first tier 402 at a bottom level near the floor, a second tier 404, and a third tier 406 at a top level.

During reconfiguration, each tier of the display may be rotated or reconfigured independently of the other tiers. In one non-limiting example, the first tier 402 may be rotated to the left to move sides 408 and 410 to the opposite side of the display, the second tier 404 may be kept stationary, and the third tier 406 may be moved to the right to bring side 414 into alignment with side 412.

In another example, the first tier 402 and second tier 404 may be kept stationary, while only the top tier 406 is rotated to the left to bring side 416 into alignment with side 412. In still another example, the tiers 402, 404, and 406 may all be reconfigured simultaneously.

FIG. 5 is an exemplary block diagram illustrating a configurable product display. The configurable product display 500 in this example is a circular, round, or oval-shaped display. The display controller detects the user 502 approaching the configurable product display 500. In this non-limiting example, the display controller identifies item 506 as a suggested item for the user 502. The display controller reconfigures the display by autonomously rotating the configurable product display 500 in a counterclockwise direction to reorient the item 506 toward the user 502. The display 500 rotates under control of the display controller to present a different item 504 to a user.

FIG. 6 is an exemplary flow chart illustrating operation of the display controller to autonomously reconfigure a configurable product display. The process shown in FIG. 6 may be performed by a display customization component executing on a display controller device, such as, but not limited to, the display controller 108 in FIG. 1 or the display controller 206 in FIG. 2.

The display controller analyzes sensor data associated with a detected user at operation 602. The sensor data is received from one or more sensors, such as the set of sensors 110 in FIG. 1, the set of sensors 208 in FIG. 2, or the set of sensors 314 in FIG. 3. The set of sensors may be integrated within the display controller or located externally to the display controller. The sensor data may include image data from one or more cameras.

The display controller determines whether a detected user is identified at operation 604. The detected user may be identified using facial recognition. The user may also be identified by a user device associated with the user pinging the display controller to obtain customized display based on the user's preferences.

If the user is not identified, the display controller identifies a set of one or more characteristics associated with the user at operation 606. The display controller generates a set of suggested product preferences based on the set of characteristics at operation 608. The set of suggested product preferences may be generated based on the characteristics and preferences data correlating one or more products to each characteristic in the set of characteristics.

If the user is identified at operation 604, the display controller retrieves the set of suggested product preferences for the user at operation 610. The set of suggested product preferences may be retrieved from a set of databases including product preferences for the user, such as the set of databases 322 in FIG. 3.

The display controller identifies one or more suggested item(s) associated with the configurable product display at operation 612. The suggested item(s) are items currently being displayed on or inside the configurable product display. The suggested item(s) are identified based on the current set of products being displayed by the configurable product display, the current location of the user, the preferences data associated with the user, and the set of suggested product preferences.

The display controller reconfigures the product display to reorient the suggested item(s) relative to the user at operation 614. The suggested item(s) may be reoriented by rotating or otherwise changing a configuration of one or more shelves associated with the configurable product display. The process terminates thereafter.

While the operations illustrated in FIG. 6 are performed by a display controller or other computing device, aspects of the disclosure contemplate performance of the operations by other entities. For example, a cloud service may perform one or more of the operations. While the example operations provided herein refer to a suggested or preferred item, a suggested or preferred service may also be identified in a similar manner.

FIG. 7 is an exemplary flow chart illustrating operation of the display controller to reorient an item associated with a product display toward a user. The process shown in FIG. 7 may be performed by a display customization component executing on a display controller device, such as, but not limited to, the display controller 108 in FIG. 1 or the display controller 206 in FIG. 2.

The display controller identifies a current location of a suggested item associated with a product display at operation 702. The current location is a location of the suggested item within or on the product display. The location may be on a shelf, level, tier, row, peg, or other part of the product display, for example. The product display may be a configurable product display such as the set of configurable product displays 102 in FIG. 1, the configurable product displays 202 or 204 in FIG. 2, the set of robotic product displays 300 in FIG. 3, the product display 400 in FIG. 4, or the product display 500 in FIG. 5.

The display controller determines whether the item is oriented toward the detected user at operation 704. The display controller utilizes the current location of the user and the location of the suggested items relative to the display to determine whether the item is oriented toward the user. The display controller may utilize image data from one or more cameras to determine the location of the user and/or the location of the suggested item. In other examples, the display controller may utilize RFID data associated with the items of the product display to determine the current items associated with the product display and the location of the items. The RFID data is obtained by an RFID reader in the set of sensors. In still other examples, the display controller may access a product display configuration database that includes the identification and location of items on configurable product displays within a given environment.

If the item is not oriented toward the user at 704, the display controller generates configuration instructions to reorient the item toward the user at 706. The display controller may generate the instructions locally to the configurable product display or remotely to the configurable product display. The instructions indicate which shelves in the product display are to be reconfigured, in which direction shelves should be moved or rotated, and/or how far shelves should be moved to bring the item within view of the user.

The display controller reconfigures the product display in accordance with the configuration instructions at operation 708. The reconfiguration changes the orientation of one or more shelves or items on display. The reconfiguration may occur by rotating, sliding, or otherwise moving at least a portion of the display. The reconfiguration may be performed by the display controller sending instructions to an actuator, which performs the reconfiguration. The process terminates thereafter.

While the operations illustrated in FIG. 7 are performed by a display controller or other computing device, aspects of the disclosure contemplate performance of the operations by other entities. For example, a cloud service may perform one or more of the operations. While the example operations provided herein refer to a suggested or preferred item, a suggested or preferred service may also be identified in a similar manner.

FIG. 8 is an exemplary flow chart illustrating operation of the display controller to process feedback associated with reconfiguration of a product display. The process shown in FIG. 8 may be performed by a display customization component executing on a display controller device, such as, but not limited to, the display controller 108 in FIG. 1 or the display controller 206 in FIG. 2.

The display controller reconfigures a product display to reorient an item towards a user based on configuration instructions at operation 802. The product display may be reconfigured by the display controller directly or by an actuator under the control of the display controller, such as the actuator 302 in FIG. 3. The display controller processes feedback data to determine user receptivity to the reconfiguration of the product display at operation 804. The feedback data is received from one or more sensors, such as the set of sensors 110 in FIG. 1, the set of sensors 208 in FIG. 2, or the set of sensors 314 in FIG. 3. The feedback data may include image data.

The display controller updates the product preferences database at operation 806. The product preferences database is updated to indicate whether the user was receptive to the suggested item or unreceptive to the suggested item. A user is receptive if the user looked at the item, picked the item up, placed the item in a shopping cart, or purchased the item.

The display controller determines if the user is still within the detection zone of the product display at operation 808. If yes, the display controller updates the configuration instructions at operation 810. The updated configuration instructions include updated configurations to reorient one or more other suggested items toward the user. The display controller iteratively executes operations 802 through 810 until the user is no longer within a detection zone of the set of sensors associated with the configurable product display. The process terminates thereafter.

While the operations illustrated in FIG. 8 are performed by a display controller or other computing device, aspects of the disclosure contemplate performance of the operations by other entities. For example, a cloud service may perform one or more of the operations. While the example operations provided herein refer to a suggested or preferred item, a suggested or preferred service may also be identified in a similar manner.

### Additional Examples

In some examples, reconfiguring product displays autonomously and customized for users increases user interaction with products and displays, improves user experience and satisfaction, reduces user time spent browsing for desired items by reconfiguring shelves to make desired items more visible, and increases sales. Moreover, the configurable product displays enable improved user awareness of available items, sale items, and other preferred items.

Alternatively, or in addition, to the other examples described herein, examples include any combination of the following:
the set of sensors includes at least one of an image capture device, a pressure sensor, a touch sensor, an infrared sensor, a microphone, or a motion sensor;
at least one image capture device that captures an image of the at least one detected user, the display controller using the captured image to identify a set of suggested product preferences for the detected user;
a preferences database having a plurality of product preference profiles, the display controller generating a set of suggested product preferences for the at least one detected user based at least in part on the product preference data;
at least one actuator, associated with at least one shelf of the at least one robotic product display, that automatically rotates the at least one shelf to re-configure the at least one robotic product display in accordance with the generated configuration instructions;
a machine learning component that analyzes the obtained sensor data to generate the set of suggested product preferences and identifies at least one item associated with the set of robotic product displays to be re-oriented towards the at least one detected user;
identifying optimal item placement of at least one item located on the at least one configurable product display based on at least one identified characteristic associated with the detected user and the set of suggested product preferences;
obtaining sensor data from one or more sensors;
processing the obtained sensor data to identify one or more characteristics associated with the detected user;
obtaining sensor data from one or more sensors;
processing the obtained sensor data to generate feedback associated with the autonomous reconfiguration of the at least one configurable product display;
the generated feedback corresponding to at least one of whether the detected user selected at least one item from the autonomously reconfigured configurable product display, whether the detected user indicated an interest in the at least one item re-oriented toward the detected user in accordance with the generated configuration instructions, or whether the detected user ignored the autonomously reconfigured configurable product display;
receiving a request from an application running on a mobile user device associated with a user;
detecting the user within the detection zone of the set of configurable product displays based on the received request;
determining the set of suggested product preferences for the detected user based at least in part on a product preference history associated with the application;
receiving feedback associated with detected user actions in response to the autonomous reconfiguration of the set of configurable product displays;
processing the received feedback to update a product preference database;
using the updated product preference database to determine a next set of suggested product preferences;
generating configuration instructions for controlling the autonomous reconfiguration based on the determined set of suggested product preferences, a set of products associated with the set of configurable product displays, and a current location of the detected user to autonomously reconfigure at least a portion of the at least one configurable product display in the set of configurable product displays to orient an item relative to the current location of the detected user;
identifying optimal item placement of at least one item located on the at least one configurable product display based on at least one identified characteristic associated with the detected user and the determined set of suggested product preferences;
detecting a plurality of users within the location comprising the set of configurable product displays;
identifying one or more characteristics for the individual users of the detected plurality of users;
determining an average user for the detected plurality of users based on the identified one or more characteristics, the average user corresponding to at least one common characteristic identified as shared by the detected plurality of users;
determining the set of suggested product preferences based on the at least one identified common characteristic of the average user;
detecting a plurality of users within the location comprising the set of configurable product displays;
identifying one or more individual users of the detected plurality of users;
determining a priority user of the detected plurality of users based on the identified one or more individual users;
determining the set of suggested product preferences based on the determined priority user;
sending a notification of detection of the user entering the location associated with the set of configurable product displays to a display customization component on a cloud server;
receiving the configuration instructions from the display customization component;
sending the obtained sensor data associated with the detected user to a display customization component on a cloud server;
receiving the set of suggested product preferences for the detected user from the display customization component;
detecting a plurality of users within the location comprising the set of configurable product displays;
identifying one or more characteristics for the individual users of the detected plurality of users;
determining a sub-set of detected users within the detected plurality of users based on the identified one or more characteristics;
determining the set of suggested product preferences based on the determined sub-set of detected users.

At least a portion of the functionality of the various elements in FIG. 1, FIG. 2, and FIG. 3 may be performed by other elements in FIG. 1, FIG. 2, and FIG. 3, or an entity (e.g., processor, web service, server, application program, computing device, etc.) not shown in FIG. 1, FIG. 2, or FIG. 3.

In some examples, the operations illustrated in FIG. 1, FIG. 2, and FIG. 3 may be implemented as software instructions encoded on a computer readable medium, in hardware programmed or designed to perform the operations, or both. For example, aspects of the disclosure may be implemented as a system on a chip or other circuitry including a plurality of interconnected, electrically conductive elements.

While the aspects of the disclosure have been described in terms of various examples with their associated operations, a person skilled in the art would appreciate that a combination of operations from any number of different examples is also within scope of the aspects of the disclosure.

The term “Wi-Fi” as used herein refers, in some examples, to a wireless local area network using high frequency radio signals for the transmission of data. The term “BLUETOOTH” as used herein refers, in some examples, to a wireless technology standard for exchanging data over short distances using short wavelength radio transmission. The term “cellular” as used herein refers, in some examples, to a wireless communication system using short-range radio stations that, when joined together, enable the transmission of data over a wide geographic area. The term “NFC” as used herein refers, in some examples, to a short-range high frequency wireless communication technology for the exchange of data over short distances.

While no personally identifiable information is tracked by aspects of the disclosure, examples have been described with reference to data monitored and/or collected from the users. In some examples, notice may be provided to the users of the collection of the data (e.g., via a dialog box or preference setting) and users are given the opportunity to give or deny consent for the monitoring and/or collection. The consent may take the form of opt-in consent or opt-out consent.

### Exemplary Operating Environment

Exemplary computer-readable media include flash memory drives, digital versatile discs (DVDs), compact discs (CDs), floppy disks, and tape cassettes. By way of example and not limitation, computer readable media comprise computer storage media and communication media. Computer storage media include volatile and nonvolatile, removable and non-removable media implemented in any method or technology for storage of information such as computer readable instructions, data structures, program modules and the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, and other solid-state memory. In contrast, communication media typically embody computer-readable instructions, data structures, program modules, or the like, in a modulated data signal such as a carrier wave or other transport mechanism and include any information delivery media.

Although described in connection with an exemplary computing system environment, examples of the disclosure are capable of implementation with numerous other general purpose or special purpose computing system environments, configurations, or devices.

Examples of well-known computing systems, environments, and/or configurations that may be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein.

In examples involving a general-purpose computer, aspects of the disclosure transform the general-purpose computer into a special-purpose computing device when configured to execute the instructions described herein.

The examples illustrated and described herein as well as examples not specifically described herein but within the scope of aspects of the disclosure constitute exemplary means for autonomous configuration of a product display. For example, the elements illustrated in FIG. 1, FIG. 2, and FIG. 3, such as when encoded to perform the operations illustrated in FIG. 6, FIG. 7, and FIG. 8, constitute exemplary means for autonomously changing a configuration of at least a portion of at least one robotic product display in a set of robotic product displays to re-orient at least one item associated with the at least one robotic product display relative to a position of at least one user; exemplary means for detecting at least one user within a detection zone of the set of robotic product displays; exemplary means for obtaining sensor data associated with the at least one detected user within the detection zone from the set of sensors; exemplary means for analyzing the obtained sensor data to determine a set of suggested product preferences for the at least one detected user; exemplary means for generating configuration instructions for the at least one robotic product display based on the determined set of suggested product preferences; and exemplary means for controlling the at least one robotic product display in the set of robotic product displays based on the generated configuration instructions.

In other examples, the elements illustrated in FIG. 1, FIG. 2, and FIG. 3, such as when encoded to perform the operations illustrated in FIG. 6, FIG. 7, and FIG. 8, constitute exemplary means for detecting a user within a detection zone of a set of configurable product displays; constitute exemplary means for determining a set of suggested product preferences for the detected user; constitute exemplary means for generating configuration instructions based on the determined set of suggested product preferences, a set of products associated with the set of configurable product displays, and a current location of the detected user; and constitute exemplary means for autonomously reconfiguring at least one configurable product display in the set of configurable product displays based on the generated configuration instructions.

In still other examples, the elements illustrated in FIG. 1, FIG. 2, and FIG. 3, such as when encoded to perform the operations illustrated in FIG. 6, FIG. 7, and FIG. 8, constitute exemplary means for obtaining, by a display controller, sensor data from one or more sensors, the sensor data used to detect a user entering a location comprising a set of configurable product displays; exemplary means for identifying, by the display controller, at least one characteristic associated with the detected user; exemplary means for determining, by the display controller, a set of suggested product preferences associated with the at least one identified characteristic; and exemplary means for controlling, by the display controller, autonomous reconfiguration of at least one configurable product display in the set of configurable product displays based on the determined set of suggested product preferences.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system for autonomous configuration of a product display, the system comprising:
a set of robotic product displays that autonomously change a configuration of at least a portion of at least one robotic product display in the set of robotic product displays to re-orient at least one item associated with the at least one robotic product display relative to a position of at least one user;
a set of sensors configured to detect the at least one user within a detection zone of the set of robotic product displays; and
a display controller, implemented on at least one processor, communicatively coupled to the set of robotic product displays and the set of sensors, that obtains sensor data associated with the at least one detected user within the detection zone from the set of sensors, analyzes the obtained sensor data to determine a set of suggested product preferences for the at least one detected user, generates configuration instructions for the at least one robotic product display based on the determined set of suggested product preferences, and controls the at least one robotic product display in the set of robotic product displays based on the generated configuration instructions.

2. The system of claim 1, wherein the set of sensors includes at least one of an image capture device, a pressure sensor, a touch sensor, an infrared sensor, a microphone, an RFID sensor, or a motion sensor.

3. The system of claim 1, wherein the set of sensors further comprises:
at least one image capture device that captures an image of the at least one detected user, the display controller using the captured image to identify a set of suggested product preferences for the detected user.

4. The system of claim 1, further comprising:
a product preferences database having a plurality of product preference profiles, the display controller generating a set of suggested product preferences for the at least one detected user based at least in part on product preference data associated with one or more users.

5. The system of claim 1, wherein the set of robotic product displays further comprises:
at least one actuator, associated with at least one shelf of the at least one robotic product display, that automatically rotates the at least one shelf to re-configure the at least one robotic product display in accordance with the generated configuration instructions.

6. The system of claim 1, wherein the display controller further comprises:
a machine learning component that analyzes the obtained sensor data to generate the set of suggested product preferences and identifies at least one item associated with the set of robotic product displays to be re-oriented towards the at least one detected user.

7. A method for autonomously configuring product displays, the method comprising:
detecting a user within a detection zone of a set of configurable product displays;
identifying a set of suggested product preferences for the detected user;
generating configuration instructions based on the determined set of suggested product preferences, a set of items associated with the set of configurable product displays, and a current location of the detected user; and
autonomously reconfiguring at least one configurable product display in the set of configurable product displays based on the generated configuration instructions.

8. The method of claim 7, wherein generating the configuration instructions further comprises:
selecting a suggested item associated with a configurable product display based on at least one identified characteristic associated with the detected user and the set of suggested product preferences;
responsive to a determination the suggested item is within a field of view of the user, maintaining a current configuration of the configurable product display; and
responsive to a determination the suggested item is outside the field of view of the user, reconfiguring the configurable product display to reorient the item toward the user.

9. The method of claim 7, wherein determining the set of suggested product preferences further comprises:
obtaining sensor data from one or more sensors; and
processing the obtained sensor data to identify one or more characteristics associated with the detected user.

10. The method of claim 7, further comprising:
obtaining sensor data from one or more sensors; and
processing the obtained sensor data to generate feedback associated with the autonomous reconfiguration of the at least one configurable product display, wherein the generated feedback indicates user receptivity to the reconfiguration of the configurable product display.

11. The method of claim 7, wherein detecting the user further comprises:
receiving a request from an application running on a mobile user device associated with a user;
detecting the user within the detection zone of the set of configurable product displays based on the received request; and
determining the set of suggested product preferences for the detected user based at least in part on a product preference history associated with the application.

12. The method of claim 7, further comprising:
receiving feedback associated with detected user actions in response to the autonomous reconfiguration of the set of configurable product displays;
processing the received feedback to update a product preference database; and
using the updated product preference database to determine a next set of suggested product preferences.

13. One or more computer storage devices having computer-executable instructions stored thereon for autonomously configuring product displays, which, on execution by a computer, cause the computer to perform operations comprising:
obtaining, by a display controller, sensor data from one or more sensors, the sensor data used to detect a user entering a location comprising a set of configurable product displays;
identifying, by the display controller, at least one characteristic associated with the detected user;
determining, by the display controller a set of suggested product preferences associated with the at least one identified characteristic; and
controlling, by the display controller, autonomous reconfiguration of at least one configurable product display in the set of configurable product displays based on the determined set of suggested product preferences.

14. The one or more computer storage devices of claim 13 having further computer-executable instructions comprising:
generating configuration instructions for controlling the autonomous reconfiguration based on the determined set of suggested product preferences, a set of products associated with the set of configurable product displays, and a current location of the detected user to autonomously reconfigure at least a portion of the at least one configurable product display in the set of configurable product displays to orient an item relative to the current location of the detected user.

15. The one or more computer storage devices of claim 14 having further computer-executable instructions comprising:
sending a notification of detection of the user entering the location associated with the set of configurable product displays to a display customization component on a cloud server; and
receiving the configuration instructions from the display customization component.

16. The one or more computer storage devices of claim 13 having further computer-executable instructions comprising:
selecting a suggested item associated with a configurable product display based on at least one identified characteristic associated with the detected user and the set of suggested product preferences;
responsive to a determination the suggested item is within a field of view of the user, maintaining a current configuration of the configurable product display; and
responsive to a determination the suggested item is outside the field of view of the user, reconfiguring the configurable product display to reorient the item toward the user.

17. The one or more computer storage devices of claim 13 having further computer-executable instructions comprising:
detecting a plurality of users within the location comprising the set of configurable product displays;
identifying one or more characteristics for the individual users of the detected plurality of users;
determining an average user for the detected plurality of users based on the identified one or more characteristics, the average user corresponding to at least a common characteristic identified as shared by the detected plurality of users; and
determining the set of suggested product preferences based on the at least one identified common characteristic of the average user.

18. The one or more computer storage devices of claim 13 having further computer-executable instructions comprising:
detecting a plurality of users within the location comprising the set of configurable product displays;
identifying one or more individual users of the detected plurality of users;
determining a priority user of the detected plurality of users based on the identified one or more individual users; and
determining the set of suggested product preferences based on the determined priority user.

19. The one or more computer storage devices of claim 13 having further computer-executable instructions comprising:
detecting a plurality of users within the location comprising the set of configurable product displays;
identifying one or more characteristics for the individual users of the detected plurality of users;
determining a sub-set of detected users within the detected plurality of users based on the identified one or more characteristics; and
determining the set of suggested product preferences based on the determined sub-set of detected users.

20. The one or more computer storage devices of claim 13 having further computer-executable instructions comprising:
sending the obtained sensor data associated with the detected user to a display customization component on a cloud server; and
receiving the set of suggested product preferences for the detected user from the display customization component.
